(19) United States
(12) Patent Application Publication
(10) Pub. No.: US 2018/0038391 A1
(43) Pub. Date: Feb. 8, 2018

(54) METHOD FOR PRODUCING A FOAM BODY

(71) Applicant: HYDAC TECHNOLOGY GMBH, Sutzbach/Saar (DE)

(72) Inventors: Peter KLOFT, Ransbach-Baumbach (DE); Herbert BALTES, Losheim (DE)

(21) Appl. No.: 15/552,840

(22) PCT Filed: Jan. 15, 2016
(86) PCT No.: PCT/EP2016/000073

§ 371 Date: Aug. 23, 2017

(30) Foreign Application Priority Data
Mar. 20, 2015 (DE) 10 2015 003 673.4

(51) Int. Cl. F15B 1/08

(52) U.S. Cl. CPC F15B 1/086; F15B 2201/3152; F15B 2201/3154; F15B 2201/411; F15B 2201/60

(57) ABSTRACT

A method for producing a foam body, in particular for a pressure accumulator, such as a hydraulic accumulator, the bubble- or diaphragm-shaped, elastically flexible separating layer (12) of which separates two media chambers from each other within the accumulator housing, in particular a gas working chamber from a liquid chamber (18), with at least the following production method steps: —introducing a flowable, preferably liquid, foam material into the pressure accumulator, said foam material being at least partially surrounded by the separating layer (12), —curing the foam material in the pressure accumulator, and in the process—building up a pressure gradient, in which the visibly curing foam material expands the separating layer (12) from an originally partially filled starting state in the direction of an end state, in which the accumulator is finally filled with the cured foam (38).

The invention relates to a method for producing a foam body, in particular for a pressure accumulator, such as a hydraulic accumulator, the bladder- or diaphragm-shaped, elastically flexible separating layer of which separates two media chambers from each other within the accumulator, in particular a gas working chamber from a fluid chamber.

A pressure accumulator is known from WO 2013/056834 A1, which pressure accumulator consists of at least one accumulator housing, which has at least one connection for a pressurizing medium, in particular in the form of a fluid, which can be stored in the accumulator housing, wherein a filling material is at least partially introduced into the accumulator housing, which has cavities or forms at least one cavity for the at least partial receiving of this pressurizing medium, wherein the inside of the accumulator housing is fully filled with the filling material, so that said filling material is in full-surface contact with a wall of the accumulator housing.

If, in the known solution, the filling material is formed as foam, in particular polyurethane foam, thickness differences in the foam material can be generated by means of multiple injections or applications of foam. It is thus advantageously possible to obtain a gradient-type structure of the foam material such that a very thick material is used on the inlet side of the accumulator, and said material then changes in the direction of the opposite side of the accumulator housing with increasingly open pores or with lesser thickness. At the point of entry of the pressurizing medium into the accumulator housing body an increased resistance can then be built up in that the barrier property of the foam or of another filling material is increased accordingly.

A pressure accumulator in the form of a hydraulic accumulator is known from WO 2013/056835 A1 having at least one elastomeric separating element, preferably in the form of a separating diaphragm or separating bladder, which divides the accumulator housing into at least two working chambers, one of which working chambers receives the one pressurizing medium, in particular in the form of a fluid, and the other working chamber receives the other pressurizing medium, in particular in the form of a working gas, such as nitrogen gas, wherein a foam-like filling material is at least partially introduced into the accumulator housing, which is delimited or surrounded by the separating element.

In order to define the storage capacity in the accumulator housing accordingly, the filling material, which in turn preferably consists of a polyurethane foam material, can be introduced as a solid form block into the accumulator with a predeterminable volume level, wherein the filling material then creates a cavity at least inside the accumulator housing, which cavity can be filled with the respective working medium (fluid and/or gas). It is thus preferably provided that the filling material is introduced in an already hardened, cellular structure as an open-pore finished foam form block into the cavity of the respective accumulator housing of a pressure accumulator.

Depending on the formation of the completely designed and produced foam-like filling material before its installation in the accumulator, a high storage capacity is obtained for the thus modified accumulator and, in addition, the stiffness of damping during operation of the accumulator can be correspondingly influenced. Furthermore, during operation of the accumulator, a homogenous temperature profile is obtained for the respective working media to be introduced and removed. The introduction of the already fully-foamed, in other words, hardened foam material and filling material, if appropriate, together with the accumulator bladder, into the accumulator nevertheless often presents issues, as the free available installation openings of the respective accumulator housing are kept small for system-related reasons, which means that it is not possible to avoid damage to the foam and/or to the elastomer material of the separating layer during the introduction into the accumulator housing. In particular, it is often necessary to divide the accumulator housing into several segments in order to simplify the introduction of the foam, which segments must subsequently be joined together by means of a laser joint welding for example, which on the one hand involves intensive work and on the other hand compromises the homogeneity and thus the pressure stability of the wall of the accumulator housing. Because of the large number of work processes that this involves, the production of the known pressure accumulator solutions is time-intensive and thus cost-intensive. The costly production also prevents the design of the respective accumulator as a disposable component, which is a requirement of the rapidly modernizing market which is efficiency-oriented.

Based on this prior art, the problem addressed by the invention is therefore to provide a pressure accumulator which, while retaining the advantages of the prior art such as the increased storage capacity and the temperature stability and pressure stability, helps to avoid the described disadvantages, and which can thus be designed in a technically reliable and functionally reliable manner and which can be produced with low labor costs and in a cost-efficient manner. This problem is solved by a method for producing such a pressure accumulator having the features of Claim 1 in its entirety.

By contrast with the prior art, in the method according to the invention at least the following method steps are used in the production of the pressure accumulator:
introduction of a flow-capable, preferably fluid, foam material into the pressure accumulator, which is at least partially surrounded by the separating layer,
hardening of the foam material in the pressure accumulator, and thereby
building up a pressure gradient, in which the increasingly hardening foam material expands the separating layer from an original partially-filled starting state towards a final state, in which the accumulator is finally filled with the hardened foam.

By contrast with the known methods therefore, an already finished foam is not introduced in block form into the pressure accumulator with its separating layer, but rather a flow-capable, preferably fluid, foam material is introduced which, after its introduction into the pressure accumulator and with the expansion of the separating layer, which occurs simultaneously during the hardening process, to its maximum designed expanded state in the accumulator, forms the finished foam block in-situ, so that all of the important steps in the foam creation towards the finished state occur directly and immediately in the accumulator and not outside of same.

The pressure gradient to be built up in order to expand the separating layer from a starting state towards its final state can be realized in a gravity-assisted manner, in other words, the introduced fluid foam material at least partially expands the separating layer simply due to its weight; however this process takes place predominantly due to volumetric expansion when the foam material hardens and the associated cavity cell formation.

It has been proven to be particularly advantageous to undertake this foam material input in an upright manner, in other words, in the vertical orientation of the longitudinal axis of the accumulator. Because the foam material arrives in the accumulator in a flow-capable, preferably fluid state, damage to the foam material is prevented. Due to the expansion of the separating layer by means of the introduced, rapidly solidifying foam material, said separating layer can be fully filled with the foam material upon hardening thereof, so that a particularly high storage capacity of foam filling material to be introduced is obtained. If, during hardening of the foam material, bubble formation occurs for the purpose of creation of the preferably open-pore foam structure, any excess material can be expelled from the inlet point for the foam material back into the environment. This means that there is neither overstressing of the pressure accumulator wall or of the elastically flexible, in particular elastomeric separating layer, which is often in the form of an accumulator bladder, but also in the form of a separating diaphragm, of the kind that is customary in diaphragm accumulators.

In one preferred embodiment of the method according to the invention it is envisaged that, by means of the hardening foam material that is introduced into the pressure accumulator and with build-up of the associated pressure gradient, the bladder-like or diaphragm-like separating layer is expanded until such time as a valve provided on the fluid side of the accumulator, in particular in the form of a poppet valve, is closed. On the basis of the described functional position of the valve, it is then possible to reach an easily verifiable conclusion as to whether there is sufficient foam material in the accumulator after the hardening process, or whether this is not yet the case, which can trigger an additional top-up operation as described above.

In one particularly preferred embodiment of the method according to the invention, the initially flow-capable, in particular fluid foam material is sprayed or injected by means of a lance-shaped input device into the accumulator housing with the separating element. The one free end of the input device preferably opens into the top half of the pressure accumulator and is to this extent guided in the gas working chamber of the accumulator, with the input device furthermore penetrating the gas connection of the accumulator and being connected by means of its other free end to an admixing device for the foam material. This makes it possible to introduce the not yet hardened foam material into the pressure accumulator in a very targeted manner and, after removal of the input device from the accumulator, the hardening operation for the foam material can take place in an unimpeded manner.

By means of the admixing device, which is formed as a dynamically or statically functioning mixing head, components of the flow-capable, in particular fluid foam material are supplied to the mixing head via at least two supply lines connected to said mixing head in order to subsequently be introduced, in a corresponding predeterminable mix ratio and via the lance-shaped input device, into the gas working chamber of the accumulator, which is separated via the separating layer from the fluid chamber of the accumulator.

In particular, by means of the mixing head it is also possible to rotate the lance-shaped input device about its longitudinal axis inside the accumulator body, so that a consistent foam material input towards the separating layer of the accumulator is realized, with several dispensing nozzles also being able to be arranged at predeterminable discrete intervals from one another on the free opening end of the input device in order to thus allow standardization of the input. Furthermore, it is possible to if necessary adjust the input device viewed in the longitudinal direction of the accumulator, with respect to its effective axial input length, in order to thus allow coverage of different accumulator sizes.

The method according to the invention is explained in detail below with reference to an exemplary embodiment according to the drawings, in which:

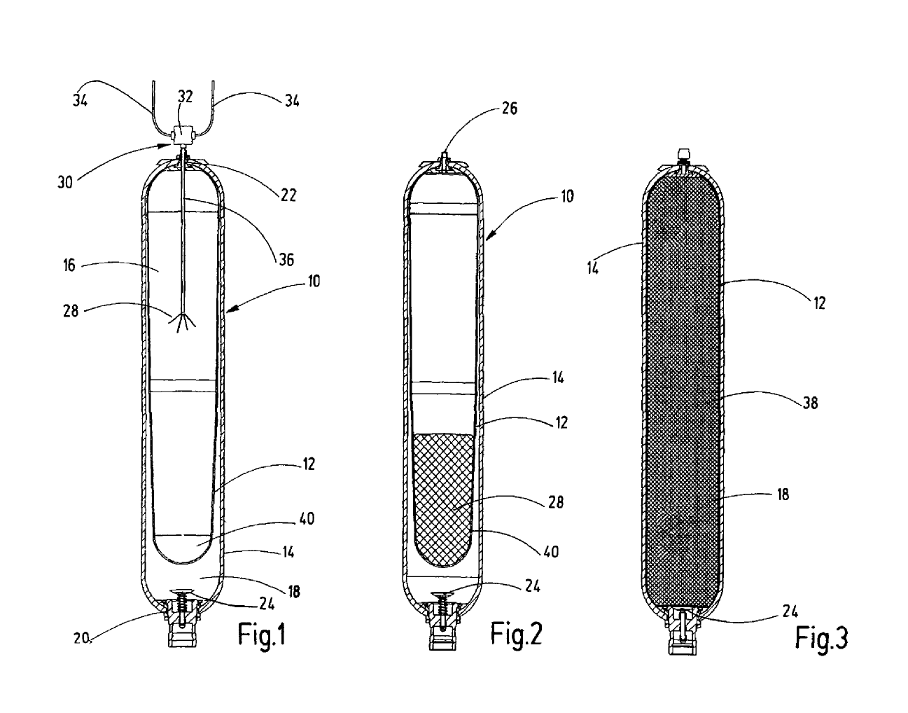

FIGS. 1 to 3 show a pressure accumulator in the form of a hydraulic accumulator with an accumulator bladder in different foam filling and production states.

The hydraulic accumulator 10 depicted in the figures is designed as a bladder accumulator, wherein the elastically flexible, in particular deformable accumulator bladder 12 separates two media chambers from each other within a pressure accumulator housing 14, in particular a gas working chamber 16 from a fluid chamber 18, which chambers serve, in the subsequent operating state of the accumulator 10, on the one hand to receive a working gas, in particular in the form of nitrogen gas, or to receive hydraulic oil. The accumulator housing 14 is formed substantially in one piece and bottle-shaped and preferably consists of a steel material or die-cast material, with the accumulator housing 14 also being able to be formed by a wrapped plastic laminate which is not depicted in detail, which is referred to as a liner construction in technical parlance. The accumulator bladder 12 forms the bladder-like, elastically flexible separating layer of the accumulator 10 and is pieced together, in particular vulcanized together, from sub-segments in accordance with the depictions of FIGS. 1 and 2. The construction of the accumulator bladder 12 in sub-segments is in particular suitable when, viewed in the axial length of the hydraulic accumulator 10, the pressure accumulator housing 14 has a correspondingly large length.

The accumulator housing 14 has on its opposite end sides two openings 20, 22, with the bottom opening 20 serving to receive a conventional closing valve, such as a poppet valve 24, and the top opening 22 is provided with a closing valve device 26 (cf. FIGS. 2 and 3), which serves for subsequent supply of the working gas and which, if necessary, permits top-up operations with the working gas. Otherwise, the closing valve device 26 usually remains closed during operation of the accumulator. If the poppet valve 24 is in an opened position, as depicted in FIGS. 1 and 2, the working fluid, commonly in the form of hydraulic oil, can reach the fluid chamber side 18 of the accumulator 10 and be stored there until the stored pressure quantity and/or filling quantity is in turn required in the hydraulic circuit (not depicted) to which the accumulator 10 can be connected. This operating method corresponds to standard accumulator operation, and accordingly it will not be addressed in further detail here. However, if the accumulator bladder 12 is in its fully elongated or expanded state, as depicted in FIG. 3, said accumulator bladder 12 presses by means of its bottom end with force-locking contact against the poppet valve 24 and thus closes the valve. An input pressure of the fluid medium is then required on the fluid side of the accumulator, which pressure is greater than the counter pressure in the accumulator bladder 12, in order to thus effect an opening operation for the poppet valve 24.

In order to obtain an operational hydraulic accumulator 10, said hydraulic accumulator must be correspondingly filled with a foam material, as will be described in detail below. For the input of the flow-capable, in particular fluid foam material, an admixing device identified as a whole with the reference numeral 30 is employed, which contains a statically or dynamically functioning mixing head 32 which, in accordance with the exemplary embodiment of FIG. 1 has two supply lines 34 connected to the mixing head 32 and which is to be placed from the outside onto the accumulator 10 to be filled. Furthermore, a lance-shaped input device 36 is connected to the mixing head 32 on the bottom side thereof, with the one free end of said input device opening into the top half of the pressure accumulator 10 and being guided in the gas working chamber 16 and with its other end the input device penetrates the top opening 22 of the accumulator housing 14, which is provided for the subsequent receiving of the closing valve device 26. For the input of the foam material, in accordance with the depiction of FIG. 1, the input device 36 is provided with corresponding spray openings or nozzle openings (not depicted in detail) in the region of the bottom end of the lance of the input device 36 in order to thus obtain a consistent foam input into the inside of the accumulator.

The foam components which can be supplied via the respective supply line 34 form, once they are brought together in the mixing head 32, a flow-capable mixture of polyols, isocyanate, catalysts, retarders, crosslinkers and stabilizers and, if appropriate, water. In particular, long-chain polyether polyols are used and the catalysts can be amine catalysts or tin catalysts. Diglycolamine is particularly preferably used as crosslinker material. However, it is also possible to use amino compounds, butanediol and alcohols. As stabilizer input material, silicone compounds have proven to be successful. The foam material components can also be supplemented with commercially available flame retardants. The above-mentioned individual components can, having been be combined with one another in advance in an obvious manner, be fed to the mixing head 32 via the supply lines 34 for further input into the accumulator bladder 12; however, there is also the possibility to preferably supply the components to the mixing head 32 separately from one another in a consecutive sequence, which mixing head then initiates the mixing and the input via the input device 36.

If the polymer polyol used for the foam has hardened, a polyurethane (PU) soft foam 38 is created, which is crosslinked by means of the additional material or the additional components in the form of the crosslinker diglycolamine. The particular polyol used substantially produces the elastic foam behavior and the high recovery capability of the introduced hardened foam 38. The preferably open-cell foam 38 has a recovery capability of 97% to 98% and the above-mentioned 3D structure of the foam 38 ensures an optimal heat transfer.

As can be seen in particular from FIG. 2, the still fluid foam material 28 is collected in the bottom accumulator bladder end 40 with the input amount individually required for the respective accumulator type, and then the accumulator 10 is closed in a pressure-tight manner via the closing valve device 26 at the top end. As a result of the introduced components of the foam material 28, the latter then hardens and thereby expands in volume up to the final state according to the depiction of FIG. 3, in which the poppet valve 24 is then closed. In particular, the build-up of a pressure gradient occurs during the hardening of the foam material 28 in the pressure accumulator 10, during which build-up the increasingly hardening foam material 28 expands the separating layer in the form of the accumulator bladder 12 from the original partially filled starting state in accordance with the depiction of FIG. 2 towards the final state, in which the accumulator 10 is finally and fully filled with the hardened foam 38 with the poppet valve 24 being closed. Due to the recovery capability of the foam 38, in the case of an opening poppet valve 24, said foam can, by means of the fluid pressure of the hydraulic circuit which is not depicted in detail, to which the accumulator 10 is connected, be forced back, in particular, compressed with regards to the open-porosity of the foam cells, so that the fluid chamber 18 in the hydraulic accumulator 10 can be filled with the oil medium until another retrieval occurs and it can thus be stored there under pressure from the compressed foam material.

The desired volumetric weight for the finished foam 38 ranges from 50 g/dm³ and 150 g/dm³. The heat capacity of the PU foam 38 should be 20° C.>1 J/gK, and it should particularly preferably be a value between 1.4 J/gK and 1.9 J/gK, with the latter value corresponding to an operating temperature of approximately 120° C. If the introduced PU soft foam 38 has a flame retardant added to it, it is thus also possible to increase the heat capacity, in particular if the flame retardant is introduced into the foam 38 as a solid. The flow resistance, which is considered to be a measure for the porosity of the foam 38, should preferably be within a value range from 1400 to 3800 Ns/m³. However, the elasticity of the foam 38 is in any case such that the foam 38 in the ready-for-use state of the accumulator 10 can be compressed by 40% of the maximum possible foam volume input. Higher values are possible. If a dry inert gas is inserted on the gas working chamber side 16, such as nitrogen, helium, argon, xenon, CF₄ or SF₆, for example, a temperature stability of between −40° C. and 140° C. is obtained in the case of a degree of crosslinking of the PU input material of >90% and when there are no volatile components.

Because the foam 38 is surrounded by the accumulator bladder 12 and thus also has no contact with the inside wall of the accumulator housing 14 or with the respective sealing materials (TPU, NBR, IIR, ECO, FKM), which are standard in accumulator construction, there is also no corresponding chemical reaction with the sealing material, which contributes to the longevity of the accumulator construction. If damage results in destruction of the hardened foam material 38 in the operational state of the accumulator according to FIG. 3, the accumulator 10 itself does not become unuseable, instead there is merely a “return” to the behavior of a standard accumulator without foam input. In addition, the above-mentioned sealing system of the accumulator 10 manages with a reduced lubricating film on the gas side and thus conforms with dry-run properties. If, contrary to expectations, foam particles or foam cells pass through via the seal or the separating layer material to the fluid side 18 of the accumulator 10, this input of foreign materials into the fluid does not lead to damage of the hydraulic system, because the PU foam does not have any observable damaging effect in this regard.

As another embodiment, which is not however depicted or described in detail, the possibility exists to apply the method according to the invention together with the foam input in pressure accumulators which are designed as diaphragm accumulators, of the kind presented in the prior art for example in FIGS. 1 and 2 of the already mentioned PCT publication WO 2013/056835 A1.

With the hydraulic accumulator solution according to the invention and using the described production method it is possible to realize accumulators having increased storage capacity and with good temperature stability and pressure stability, which prove to be very functionally-reliable during operation and which can be produced with little labor outlay and expense. There is no equivalent of this solution in the prior art.

1. A method for producing a foam body, in particular for a pressure accumulator (10), such as a hydraulic accumulator, the bladder- or diaphragm-shaped, elastically flexible separating layer (12) of which separates two media chambers from each other within the accumulator housing (14), in particular a gas working chamber (16) from a fluid chamber (18), comprising at least the following production method steps:
introduction of a flow-capable, preferably fluid, foam material (28) into the pressure accumulator (10), which is at least partially surrounded by the separating layer (12),
hardening of the foam material (28) in the pressure accumulator (10), and thereby
building up a pressure gradient, in which the increasingly hardening foam material (28) expands the separating layer (12) from an original partially-filled starting state towards a final state, in which the accumulator (10) is finally filled with the hardened foam (38).

2. The method according to claim 1, characterized in that, by means of the hardening foam material (28) that is introduced into the pressure accumulator (10) and with build-up of the associated pressure gradient, the separating layer (12) is expanded until such time as a valve provided in the fluid chamber (18) of the accumulator (10), in particular in the form of a poppet valve (24), is closed.

3. The method according to claim 1, characterized in that the flow-capable, in particular fluid, foam material (28), is sprayed or injected by means of a lance-shaped input device (36) into the pressure accumulator (10), with the one free end of said input device opening into the top half of the pressure accumulator (10) and being guided in the gas working chamber (16) and thereby penetrating the gas connection (20) of the accumulator (10) and with the other free end of the input device outside of the pressure accumulator (10) being connected to an admixing device(30).

4. The method according to claim 1, characterized in that, by means of the admixing device (30), which is formed as a dynamically or statically functioning mixing head (32), components of the flow-capable, in particular fluid foam material (28) are supplied to the mixing head (32) via at least two supply lines (34) connected to said mixing head in order to subsequently be introduced in a corresponding predeterminable mix ratio via the lance-shaped input device (36) into the gas working chamber (16) of the accumulator (10).

5. The method according to claim 1, characterized in that the individual components which are to be mixed with one another by means of the admixing device (36) in order to create the flow-capable, in particular fluid foam material (28) are selected as follows:
polyols, in particular in the form of long-chain polyether polyols;
foaming agents, in particular in the form of water; and
crosslinkers, in particular in the form of diglycolamine, preferably supplemented with:
catalysts, in particular in the form of amine catalysts and/or tin catalysts;
retarders;
flame retardants; and
stabilizers, in particular in the form of silicone compounds.

6. The method according to claim 1, characterized in that the foam material (38) hardened in situ in the pressure accumulator (10) is formed with open cells with a recovery capability as a 3D structure of 97 to 98%.

7. The method according to claim 1, characterized in that the volumetric weight of the hardened foam material (38) is selected in a range from 50 g/dm³ to 150 g/dm³ per liter of input volume of flow-capable, in particular fluid foam material (28).

8. The method according to claim 1, characterized in that the heat capacity of the hardened foam material (38) is selected at 20° C.>1 J/gK.

9. The method according to claim 1, characterized in that the flow resistance of the foam (38) is selected in a range from 1400 to 3800 Ns/m³.

10. The method according to claim 1, characterized in that the temperature stability in a closed accumulator bladder (12) as the elastically flexible separating element and with insertion of dry inert gas as the working gas introduced into the gas working chamber (16) of the accumulator (10) is selected in a range from −40° C. to 140° C.

11. The method according to claim 1, characterized in that, on the basis of the respective selected expansion speed together with the pressure gradient values during foaming, cells are obtained in the finished foam (38) in the range from 0.01 mm³ to 375 mm³.
